(19) United States
(12) Patent Application Publication
(10) Pub. No.: US 2009/0154703 A1
(43) Pub. Date: Jun. 18, 2009

(54) Content Protection Using Encryption Keys Where only part of the private key is associated with end user data

(75) Inventors: William Pat Price, Rhome, TX (US); Timothy J. Elliott, Huntington Beach, CA (US)

Correspondence Address: Law Office of Scott C Harris Inc, PO Box 1389, Rancho Santa Fe, CA, 92067, US

(73) Assignee: VIZIO, Irvine, CA (US)

(21) Appl. No.: 11/959,224

(22) Filed: Dec. 18, 2007

(51) Int. Cl. H04L 9/00

(52) U.S. Cl. 380/277

(57) ABSTRACT

The current invention addresses the problem of securely encrypting video content or any other content where a secret symmetrical key is used to decrypt the data by a hardware device such as a DVD player. The invention uses the same length of symmetrical key as used by current technology but the key is changed for every dataset encrypted. The symmetrical key is itself contained inside a packet attached to the first encryption data set where the packet is encrypted with a device's public key. The invention further adds to the security of the asymmetrical private key where the device itself only has part of the private key and the user has the other part of the private key.

### BACKGROUND

Maintaining the rights of data owners who rent or license data to third parties has been a growing problem over the years. This problem is noticeable for digital video and music content provided on CDs, DVDs, and for content downloaded over networks. Content owners providing digital video on DVDs have long used a protection scheme known as Content Scramble System (CSS). This is a Digital Rights Management (DRM) scheme used on literally all commercially produced DVDs. The encryption methodology used is at best very weak and proved to be easily susceptible to brute force attacks.

DRM is based on a proprietary 40-bit stream cipher algorithm. The system was introduced around 1996 and has subsequently been compromised to the point that copying of DVDs for standard definition video content is simple and commonplace. The introduction of NetFlix and now BlockBuster with on-line ordering of DVD rentals has aided this practice to the point that many people use NetFlix and BlockBuster to obtain DVDs strictly for the purpose of duplicating them.

The CSS algorithm has been superseded by the Cryptomeria cipher in newer DRM schemes such as CPRM/CPPM. Also, additional types of content protection has been added to certain CDs. However, the additional content protection is necessarily limited by what the installed base of CD players are capable of playing back.

With the introduction of High Definition (HiDef) video, the content owners have begun development of yet another encryption scheme that is referred to as the Advanced Access Content System (AACS). AACS is the new standard for content distribution and digital rights management for the next generation of optical discs and DVDs.

Players incorporating AACS began appearing in 2006. Since then, several AACS decryption keys have been extracted from weakly protected software players and published on the Internet. The published keys give people the ability to play and copy add older and current DVDs encrypted with that key set.

Once each key was cracked and published, the content owners placed the key on a revocation list and stopped producing DVDs with that key. This process takes about 4 months before DVDs with the new “secret” key work their way out into the general population of DVDs. Within days after each new key is placed into production, it too has been cracked and published.

### SUMMARY

The inventors recognized that this situation with keys is indicative of a security-impairment.

The embodiments describe new techniques that make it more difficult to obtain these keys.

An embodiment obviates this need to keep the entirety of the keys secret.

According to an embodiment, encrypted content is provided without providing a complete key that will decrypt the key package associated with the actual content in the player.

### BRIEF DESCRIPTION OF THE DRAWINGS

Embodiments of the present invention are illustrated by way of example, and not by way of limitation. The following figures and the descriptions both brief and the detailed descriptions of the invention refer to similar elements and in which:

FIG. 1 depicts the basic structure of an encrypted dataset pre-pended with the key, which is itself encrypted, that will decrypt the dataset.

FIG. 2 depicts the process and the elements that go into creating the encrypted dataset and the key package.

FIG. 3 depicts the process and the elements that go into the player decrypting the key and metadata package and the content dataset.

FIG. 4 depicts the process that goes into providing the private key to the encryption key manager when the private key is completely retained in the player.

FIG. 5 depicts the process that goes into providing the private key to the encryption key manager when the private key is completely retained on a private key server.

### DETAILED DESCRIPTION

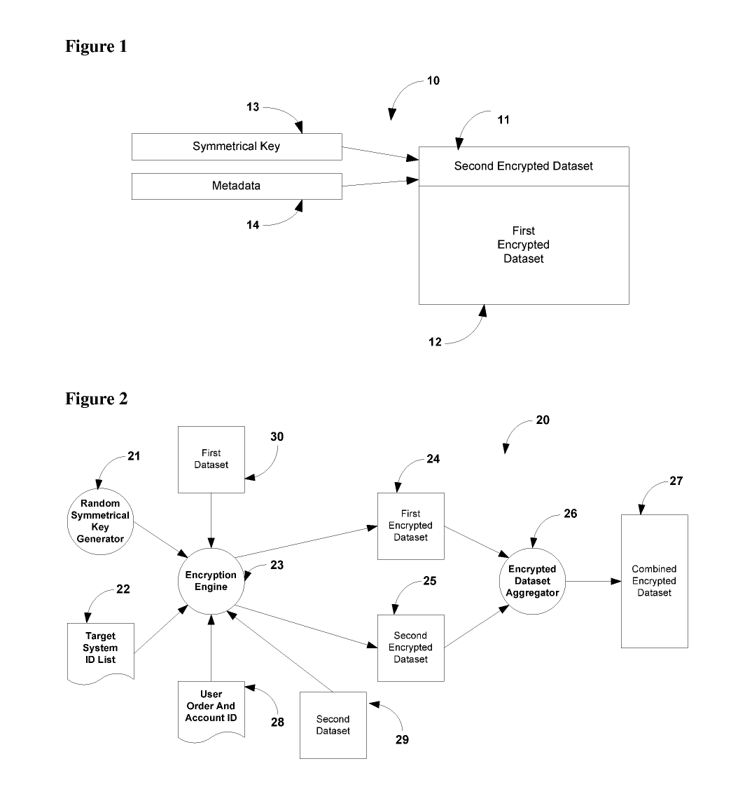

A most basic embodiment is shown in FIG. 1. This diagram shows the encrypted file playing structure (10) as a data structure formed of a combination of a First Encrypted Dataset (12) and Second Encrypted Dataset (11). Second Encrypted Dataset (11) itself has two basic elements shown as Symmetrical Key (13) and Metadata (14). Symmetrical Key (13) is encrypted with a public key associated with the user's player and is used by the user's player to decrypt First Encrypted Dataset (12). In some embodiments, the player 10 will contain the complete private key necessary to decrypt Second Encrypted Dataset (11) and thus recover Symmetrical Key (13) and Metadata (14). The metadata 14 can be any kind of information that is associated with the main content, e.g., information about the content, further enhancement information for the content that provides additional definition for the content, or supplemental information associated with the content such as interviews or the like.

In other embodiments, the user's player 10 may only contain one of a plurality of pieces of the private key necessary to decrypt Second Encrypted Dataset (11) and thus recover Symmetrical Key (13) and Metadata (14). This second embodiment may also fall into a number of sub-embodiments where the portion of the private key not possessed by user's player may instead be possessed by the user or by a private key server residing on the internet.

Another embodiment forms the Second Encrypted Dataset (11) as a plurality of encrypted datasets. Each dataset contains a Symmetrical Key (13) and Metadata (14). Each set of symmetrical key and metadata is encrypted with a unique public key, where each unique public key is associated with a specified unique player. Each player contains a private key necessary to decrypt one of the encrypted datasets within the Second Encrypted Dataset (11). This embodiment allows First Encrypted Dataset (12) to be accessed by a plurality of players, each with its own unique public and private encryption keys. However, preferably only a subset of all players can access the second encrypted dataset. In this embodiment, a “missing” portion of the private key is not possessed by user's player. This missing portion of the private key is instead possessed by the user or by a private key server on the internet.

FIG. 2 shows an alternative embodiment showing the elements and process that go into encrypting the datasets and how those datasets are processed into a Combined Encrypted Dataset (27). Encryption Engine (23) has a plurality of inputs. Encryption Engine (23) receives User Order and Account ID (28) and compares the user's ID and Account ID against Target System ID List (22) that has a list of authorized ID/accounts. This allows Encryption Engine (23) to authenticate the user and the player associated with the user.

Once the user is authenticated by the comparison between the target system ID and the user order and account ID, Encryption Engine (23) receives a highly randomized symmetrical key from Random Symmetrical Key Generator (21). This key is a one-time key that is used to encrypt First Encrypted Dataset (24) one time. This key is only used once and is never used to encrypt a second dataset for this user and player or any other user and player. Encryption Engine (23) encrypts First Dataset with the symmetrical key producing First Encrypted Dataset (24).

Encryption Engine (23) obtains the public key associated with the user's player from Target System ID List and uses that public key to encrypt Second Dataset producing Second Encrypted Dataset (25). When both datasets 24 and 25 have been encrypted, Encrypted Dataset Aggregator (26) appends or otherwise combines First encrypted Dataset (24) with Second Encrypted Dataset (25) producing Combined Encrypted Dataset (27). Combined Encrypted Dataset (27) is the dataset that is provided to the user. The dataset is provided by one or more methods such as flash memory media; hard disk drive media, optical media, network delivery, or pickup by the user at a location geographically close to the user.

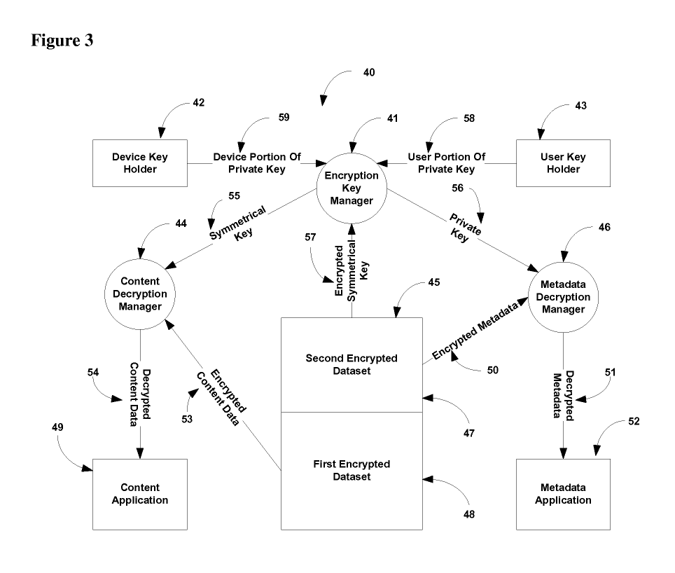

FIG. 3 shows an embodiment 40 showing the elements and process that go into a player decrypting the encrypted datasets. Encryption Key Manager (41) in this embodiment receives Device Portion Of Private Key (59) from Device Key Holder (42) and User Portion Of Private Key (58) from User Key Holder (43). In an embodiment, the User Key Holder (43) is the user who enters a pass word or pass phrase or some predetermined alphanumeric sequence of characters. In another embodiment, the User Key Holder (43) may be a secure USB flash device that contains the User Portion Of Private Key (58). The Encryption Key Manager (41) after receiving the portions of the private key, then combines the portions. Any of several different techniques can be used for this combining. In an embodiment, Encryption Key Manager (41) hashes the portions using a predetermined hashing algorithm.

After producing Private Key (56), Encryption Key Manager sends Private Key (56) to Metadata Decryption Manager (46) which then reads Encrypted Metadata (50) from Second Encrypted Dataset (45). Encryption Key Manager (41) reads Encrypted Symmetrical Key (57) from Second Encrypted Dataset (45) and decrypts Encrypted Symmetrical Key (57) producing Symmetrical Key (55) and passes it to Content Decryption Manager (44). Metadata Decryption Manager (46) receives Private Key (56) from Encryption Key Manager (41). Metadata Decryption Manager (46) reads Encrypted Metadata (50) from Second Encrypted Dataset (45) and decrypts the metadata producing Decrypted Metadata (51), which is sent to Metadata Application (52). Content Decryption Manager (44) receives Symmetrical Key (55) from Encryption Key Manager (41). Content Decryption Manager (44) reads Encrypted Content Data (53) from First Encrypted Dataset (48) and decrypts the content data producing Decrypted Content Data (54) which it sends to Content Application (49).

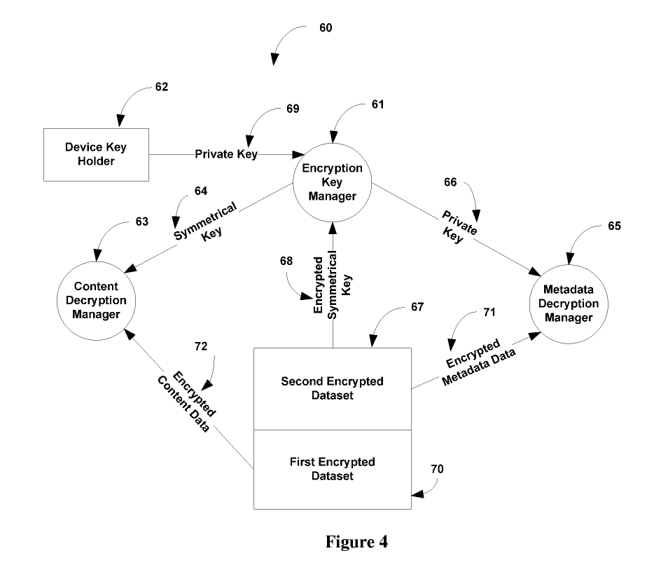

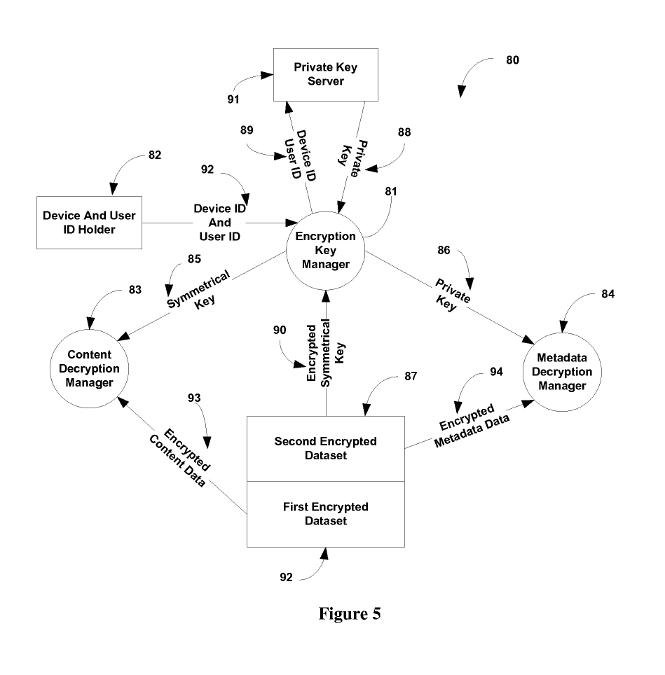

FIG. 4 shows an embodiment 60 depicted in an embodiment where the complete private key is contained wholly within the player. Encryption Key Manager (61) receives Private Key (69) from Device Key Holder (82). Encryption Key Manager (61) uses Private Key (69) to decode Encrypted Symmetrical Key (68) contained in Second Encrypted Dataset (67) producing Symmetrical Key (64) which is sent to Content Decryption Manager (63). Content Decryption Manager (63) uses Symmetrical Key (64) to decrypt Encrypted Content Data (72) contained in First Encrypted Dataset (70). Encryption Key Manager also sends Private Key (66) to Metadata Decryption Manager (65). Metadata Decryption Manager (65) uses Private Key (66) to decrypt Encrypted Metadata Data (71) contained in Second Encrypted Dataset (67).

FIG. 5 shows an embodiment (80) where the complete private key is contained wholly on a remote key server. Encryption Key Manager (81) receives the identification for the device and user in Device ID And User ID (92) from Device And User ID Holder (82). Encryption Key Manager (81) sends Device ID And User ID (92) as Device ID User ID (89) to secure remote Private Key Server (91) located on the internet. Private Key Server (91) authenticates the device and user by comparing Device ID User ID (89) against an authentication database. Once the device and user have been authenticated, Private Key Server (91) sends Private Key (88) to Encryption Key Manager (81). Encryption Key Manager (81) will use Private Key (88) to decode Encrypted Symmetrical Key (90) contained in Second Encrypted Dataset (87) producing Symmetrical Key (85) which is sent to Content Decryption Manager (83). Content Decryption Manager (83) uses Symmetrical Key (85) to decrypt Encrypted Content Data (93) contained in First Encrypted Dataset (92). Encryption Key Manager also sends Private (86) to Metadata Decryption Manager (84). Metadata Decryption Manager (81) will use Private Key (88) to decrypt Encrypted Metadata Data (94) contained in Second Encrypted Dataset (87). The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other forms of providing the key portions may be used. The application also describes only a few forms of delivering content to players, such as DVDs, and USB drives, but it should be understood that other forms could alternatively be used.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A method comprising
protecting content on a readable medium, wherein said content includes at least one video portion, said protecting including using an encryption system to encrypt said content to form encrypted content, wherein said encrypted content is decoded by a decryption key;
associating only a first part of the decryption key that will decrypt said content with a player for said medium, where said only a first part will not decrypt said content without an additional second part of key information;
associating a second part of the decryption key with a second repository, separate than said player; and
combining said first part and second part to form a combined decryption key, and using said combined decryption key to decrypt said content.

2. A method as in claim 1, further comprising requiring the user to enter user information as entered information, comparing the user information with a list of authorized user information, and authenticating the entered information, and responsive to said authenticating, carrying out an operation to obtain said additional second part of key information.

3. A method as in claim 1, wherein said additional second part of key information is stored on a separate device, that is separate from a player that plays the content.

4. A method as in claim 1, wherein said missing information is encrypted prior to said storing.

5. A method as in claim 3, wherein said separate device is a USB flash device.

6. A method as in claim 1, wherein said combining comprises mathematically combining said first part of the encryption key with said second part of the encryption key to produce a key that is used to decrypt said content.

7. A method as in claim 1, wherein said combining comprises using said second part of the decryption key to decrypt said first part of the encryption key, and using a result of said decrypt to decrypt said content.

8. A method as in claim 1, wherein said second repository is in a remote database that is remotely accessed to obtain said second part.

9. A method as in claim 1, wherein said decryption key includes a first decryption key which is used to decrypt a first encrypted data set to obtain content therefrom, and a second decryption key which is used to decrypt a second encrypted data set to obtain metadata therefrom, using a second decryption key different from the first decryption key, where said metadata relates to further information about said encrypted data set.

10. A player for encrypted data, comprising:
a player portion, reading information from a media that includes both a first encrypted data set and a second encrypted data set;
a decryption key portion, obtaining a first decryption key which is used to decrypt the first encrypted data set to obtain content therefrom using a content decryption manager, and obtaining a second decryption key which is used to decrypt the second encrypted data set to obtain metadata therefrom, using a metadata decryption manager, using a second decryption key different from the first decryption key, where said metadata relates to further information about said encrypted data set.

11. A player as in claim 10, wherein said decryption portion stores only a portion of at least one of said first and second decryption keys.

12. A player as in claim 11, further comprising an interface to an external storage part which stores at least another portion of said decryption key.

13. A player as in claim 11, further comprising an interface to a remotely accessible key storage unit which stores at least another portion of said decryption key.

14. A player as in claim 12, wherein said only a portion of said decryption key that is stored by said player includes an encrypted version of the key, and another portion is a decryption key for said encrypted version of the key.

15. A player as in claim 11, wherein said player also obtains another portion associated with said decryption key, and combines said another portion with said only a portion, and uses a combined decryption key to encrypt at least one of said data.

16. A method of playing encrypted data stored on a medium, comprising:
using a key manager to obtain one portion of the decryption key from a first source, and another portion of the decryption key from a second source;
combining the one portion and the another portion to form a combined decryption key; and
using said combined decryption key to decrypt data stored on the media.

17. A method as in claim 16, wherein said combined decryption key is used to decode only a portion of the information on the media, and further comprising requiring a second decryption key to decode other information on the media.

18. A method as in claim 17, wherein said only a portion is content on the media, and said other information is metadata indicative of the content. wherein another portion of said at least one decryption key up account information, comparing the account information with a list of authorized account information.
